(19) United States
(12) Patent Application Publication
(10) Pub. No.: US 2006/0291042 A1
(43) Pub. Date: Dec. 28, 2006

(54) Optical scanning zoom microscope with high magnification and a large field of view

(76) Inventors: Robert R. Alfano, Bronx, NY (US); Chun Wang, College Point, NY (US); Pavel Shumyatsky, Tenafly, NJ (US); Manuel E. Zevallos L., Woodhaven, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/435,959

(22) Filed: May 17, 2006

Related U.S. Application Data
(60) Provisional application No. 60/681,433, filed on May 17, 2005.

(51) Int. Cl. G02B 21/00

(52) U.S. Cl. 359/368

(57) ABSTRACT

The computer-controlled optical scanning high magnification microscope imaging system with a large field of view disclosed herein overcomes a previous inability to achieve simultaneous high magnification and large field of view in microscopes. The subject imaging system includes galvanometer scanners, a CCD camera and high brightness LED sources at different wavelengths for rapid acquisition of a large number of high-resolution segmented tile images with a magnification of 800× each. The numerous segmented tiles combine to form a larger viewing field of the target, resulting in a compound image with an effective enlarged viewing area of 1.6×1.2 mm². The speed and sensitivity of the system make it suitable for high resolution image monitoring of a small segmented area of dimensions 320×240 μm² with a 4 μm resolution. The microscope can zoom in on each segment of the target without lost of resolution to attain a great degree of spatial detail. With its special capacities, this microscope would be beneficial to medicine, biology, semiconductor inspection, device analysis and quality control, as well as with multiphoton and fluorescence microscopes to image large fields with high resolution.

### CROSS-REFERENCE TO RELATED APPLICATION

The subject application is based on Provisional Pat. Appln. No. 60/681,433 filed on May 17, 2005, the entire contents of which are incorporated by reference. This utility application is being filed within the statutory term for claiming priority based on a provisional application.

### BACKGROUND OF THE INVENTION

1. Field of the Invention

This patent application generally relates to microscopes, in particular with an optical scanning zoom microscope that provides both high level of magnification and a wide range of view.

2. Description of the Prior Art

Microscopes are important instruments capable of producing a magnified image of small objects on a micron scale. They are commonly used in many diverse scientific and industrial applications including manufacturing inspection and high-technology quality control in areas of cell research, tissue analysis, semiconductor inspection, devices analysis, biological and medical imaging, and metallurgical analysis. One of the important biological applications using microscopes is the study of changes in cellular structure during mitosis, apoptosis, or the interaction between cells. Events of interest typically occur only in a small percentage (<2%) of a population at one time. A method of selecting a particular cell from a larger population is required. For biological and other observations such as cells within a PAP smear, there has been a need for a microscope with a large view field which retains a high level of magnification for biological observations and specimen manipulation. It appears from the underlying physics that the magnification and field of view are two characteristic parameters of a microscope which are inversely related due to the underlying principles of optics. High magnification implies a small field of view. There is a need in microscopy for a novel approach to achieve both high magnification and a large field of view. Conventional optical microscopes suffer from the limitation that high magnification reduces the size of the field of view.

The common approach used to overcome this problem is to introduce a movable platform supporting the sample, move the microscope itself and/or change the objective lens. With the advance of digital image processing and real-time computation, the stage motion can be guided to observe the image while automatically positioning the specimen. The motion of the stage introduces undesirable disturbances to the specimen and the movement of the stage needs to be highly accurate for the proper observation of the specimen. The stage needs precision mechanics and a time-consuming calibration to gain the desired accuracy to work at high rates of speed. The approach of changing the objective lens requires one to realign the position of the sample.

### SUMMARY OF THE INVENTION

The proposed invention provides a novel and useful optical scanning zoom microscope with capability of high magnification and large field of view at the same time. The invention encompasses an optical system for the fast acquisition of a large number of high resolution segmented tile images with a magnification of 800× for each tile. The segmented tiles are combined together to form a larger view field of the target. The resultant combination of the captured segmented tile images create an effective enlarged viewing area with dimensions 1.6×1.2 mm². The system has enough speed and sensitivity for high resolution imaging monitoring application dealing with small segmented areas of dimensions 320×240 μm² with a 4 μm resolution. Each segment of the target can be zoomed in without degrading the high resolution quality. This invention can be utilized in the fields of medicine, biology, semiconductor inspection, device analysis and quality control.

To overcome the incompatibility of high magnification and large field of view, a new type of computer-controlled compact rapid scanning microscope has been developed which possesses an electronic zoom on different segments of a smaller region of a target which are then combined to form a large image. The segmented tiles are recombined using galvanometer scanners to produce a large target by matching up the tiles using image processing software. The system incorporates a CCD camera with a high brightness LED light source for acquisition of high resolution images on the μm scale with a magnification of 800× and a large field of view on the ˜mm² scale. The microscope images a small tile region of the specimen and combines the segmented tile images to create a large field of view of the target.

The present invention discloses an optical system for the fast acquisition of a large number of high resolution segmented tile images with magnification of 800× each. A large number of segmented tiles are combined together to form a larger viewing field of a target with an effective enlarged viewing area of dimensions totaling 1.6×1.2 mm². The system's speed and sensitivity makes it suitable for high resolution imaging monitoring of small segmented areas of dimensions 320×240 μm² and with a 4 μm resolution. Each segment of the target can be zoomed in without affecting the high resolution quality.

The present invention of the computer-controlled optical scanning high magnification microscope imaging system with a large field of view consists of several main parts: light source, scanning system, lens, imaging system, computer controlling system and software. This invention solves the incompatibility of achieving both high magnification and a large field of view. This new microscope imaging system achieves both high magnification and a large field of view, opening the way to applications in the fields of medicine, biology, semiconductor inspection, device analysis and quality control. The unit can be used for: PAP smear to measure/image a small area of group of cells to determine cancerous, normal or abnormal cells; and histology to measure/image small area of tissues. The image obtained from the sample or target could be from backscattered light, transmitted light, fluorescence light, or phosphorescence light.

In the present invention, the uniform light source includes LEDs, a diffuser, an array of beam collimating optics and a beam splitter for coupling.

In preferred embodiments, the x, y scanning system may include two one-dimensional galvanometers with two plane mirrors having their axis of rotation perpendicular to each other. The two mirrors can be scanned over the target in a prescribed pattern under the control of the computer.

The microscope parts include objective lens L1 (f=8 mm, D=8 mm), imaging Lens L4 (f=30 mm, D=15 mm) and a Galilean-type optical system (5 times ratio) seated between L1 and L4 to condition the image according to the required performance such as the desired magnification and the CCD size (FIG. 1). The target is placed at the focal plane of the achromatic lens (L1) such that each ray reflecting off the object is collimated at the scanning mirrors. An iris is placed just after the lens to enhance the image contrast. Rays exit parallel to the Galilean expander and form an image on the CCD by means of the imaging lens L4. A LED array of different emitters with wavelengths from 250 nm to 1000 nm.

A photodetection system includes a CCD or a CMOS camera with scanning repetition rates as high as 30 Hz and sensitivity in the visible and near infrared region.

A computer based controlling and system includes an electronic board to manage scanning and data collection, and a software to produce a composite 2D image tile by stitching all the segmented tile images in order.

The microscope unit can be extended into mid infrared (1.2−7.0 μm) using Infrared Optics and Mid Infrared CCD, Infrared lamps from 1200-7000 nm, imaging optics and IR Optics.

The microscope unit can be used for fluorescence and multiphoton images of sample such as tissues using laser excitation.

### BRIEF DESCRIPTION OF THE DRAWINGS

Various further objects, features and advantages under present invention will be more fully appreciated as the invention will be better understood in light of the accompanying figures, in which:

FIG. 1 is a schematic diagram of the optical layout of the scanning microscope.
L1: f=8 mm, D=8 mm; L2: f=50 mm, D=25.4 mm; L3: f=−9 mm, D=9 mm;
L4: f=30 mm, D=15 mm; Array of LED, light emitting diode at different wavelength grom UV to Near Infrared 260-1000 nm;

FIG. 2 is a USAF 1951 Target and the Specification Table;

FIG. 3 are 25 segmented tile images of the USAF target;

FIG. 4 is an image of the 12^{th} segmented tile group of the USAF target of FIG. 3 with dimensions 320×240 μm²;

FIG. 5 is a full reassembled segmented image of 25 tiles of the USAF target with dimensions 1.6×1.2 mm²;

FIG. 6 is a full reassembled segmented image of 25 tiles of mouse brain tissue; and

FIG. 7 is a zoomed-in or enlarged image of an area of interested of the mouse brain tissue corresponding to 2nd segmented tile with high resolution unaltered.

### DETAILED DESCRIPTION OF THE PREFERRED EMBODIMENTS

Referring now more specifically to the drawings, in which identical or similar parts are designated by the same reference numerals throughout, and first referring to FIG. 1, this figure is a schematic diagram of the microscope system.

The system consists of several parts: a light source, a scanning system, lenses, an imaging system, an computer controlling system and software. The light source consists of the LED, a diffuser and a collimating system. The scanning system consists of two one-dimensional galvanometers with mounted mirrors-such as the M-Series optical scanners by GSI Lumonics-scanning over the target in a prescribed pattern. The microscope part consists of an objective lens L1 (f=8 mm, D=8 mm), an imaging Lens L4 (f=30 mm, D=15 mm) and a Galilean-type optical system (5 times ratio) seated between L1 and L4 to condition the image according to the required performance such as the desired magnification and the CCD active area size. The target is placed at the focal plane of the achromatic lens (L1) such that each ray reflecting off the object is collimated at the scanning mirrors. An aperture is placed just after the lens to enhance the image contrast. Rays exit parallel across the Galilean expander and form an image on the CCD by means of the imaging lens L4. The imaging system is a CCD SONY Model, XC-ST50 camera with scanning repetition rates as high as 30 Hz and a DT-3153 Frame Grabber. The XC-ST50 incorporates the latest CCD and signal processing technologies. The computer controlling system used to control the scanning system and imaging software system is composed of a HC/3 Interface Card (HelperCard II) and PC-MARK software respectively. The HC/3 is a PC Hardware Controller used with advanced GMAX systems to drive a Scan Head. The purpose of the new HC/3 is to provide a hardware link between a personal computer with a PCI bus and a GSI Lumonics beam positioning output system. It is fully compatible with the PC-MARK MT™ (Multitasking) software and WinMCL. The full scanning cycle is divided into 25 steps for image sampling. At each segmented sampling tile, the scanning mirrors come to a brief stop and a complete segmented image is acquired with a high speed CCD. After a full scanning cycle is finished, 25 segmented images are obtained. Each segmented image is 640×480 pixels. The software program used will compress each segmented image to 20%, and 25 compressed segmented tile images are stitched together in order to form a full image which can be displayed or used to guide the tasks under the microscope. A composed C++ program coordinates the motion control with the image acquisition and image processing. The mirror's size, the shape and the distance from the mirror to the lens L1, will directly affect the size of the field of view as well as the quality (such as optical and geometrical aberrations and image distortions.) as the system is working off optical axis. On the mechanical side, the settling time of the scanner will define the refreshing rate. Many of these parameters are related. For example, a large mirror will allow a large field of vision but at the cost of a longer settling time and therefore a lower refreshing rate. Higher image resolution requires more data transfer and image processing time. The entire imaging and processing time for the full 25-tile image is 2.5 s=25×0.092+0.2. For each image tile, the main contributors to the time consumption are scanning (2 ms), image acquiring (35 ms), image saving, imaging compressing and saving (55 ms). The stitching and displaying of the full image time is about 200 ms. The entire imaging and processing time for the full 25-tile image is 2.5 s.

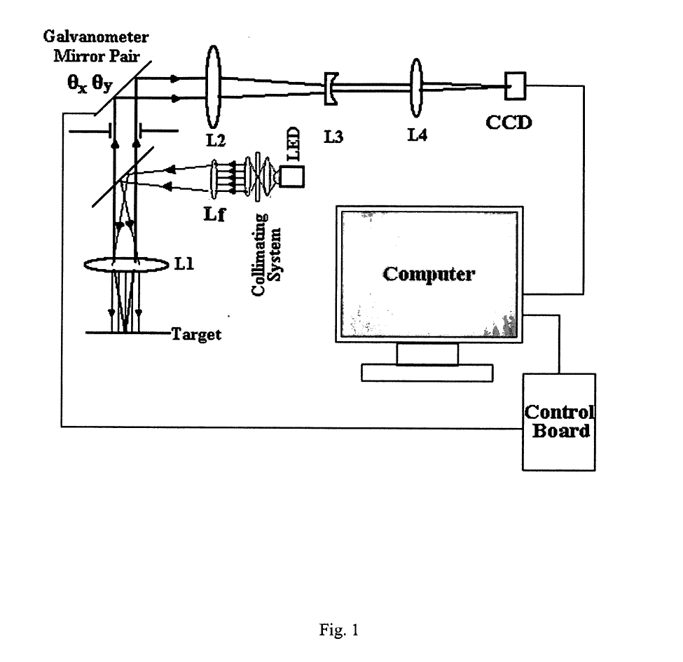

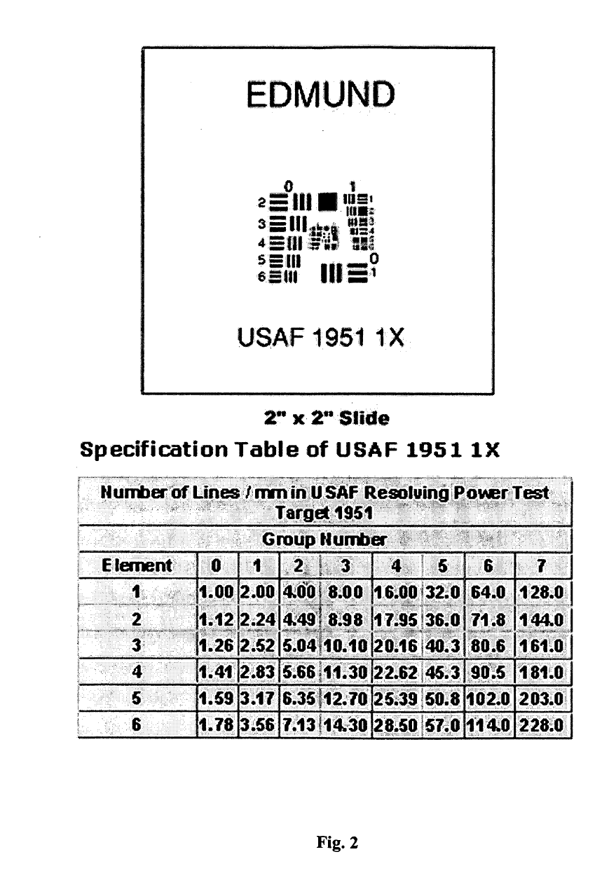

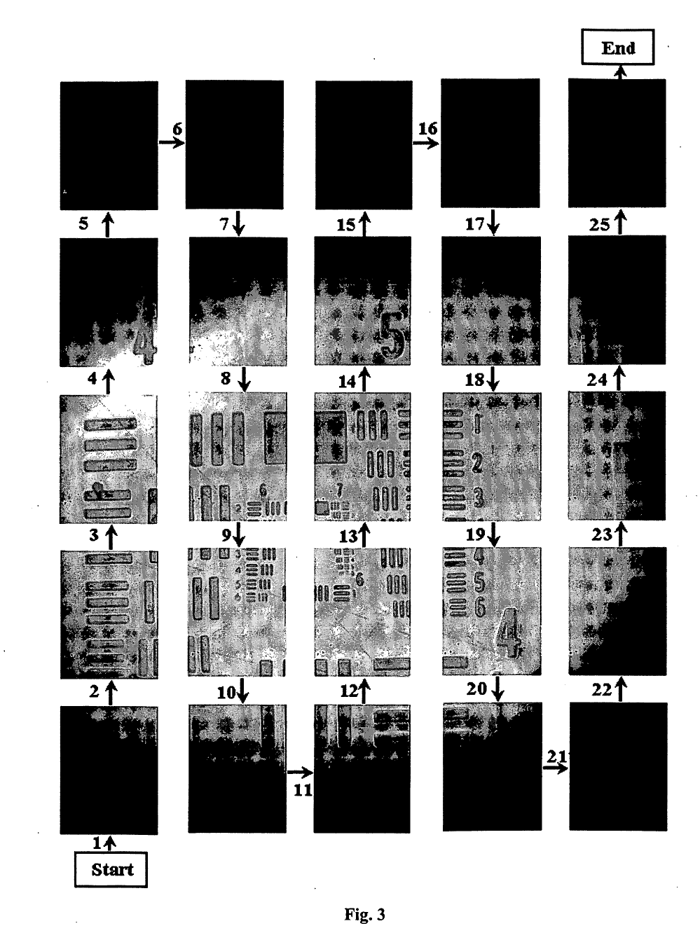

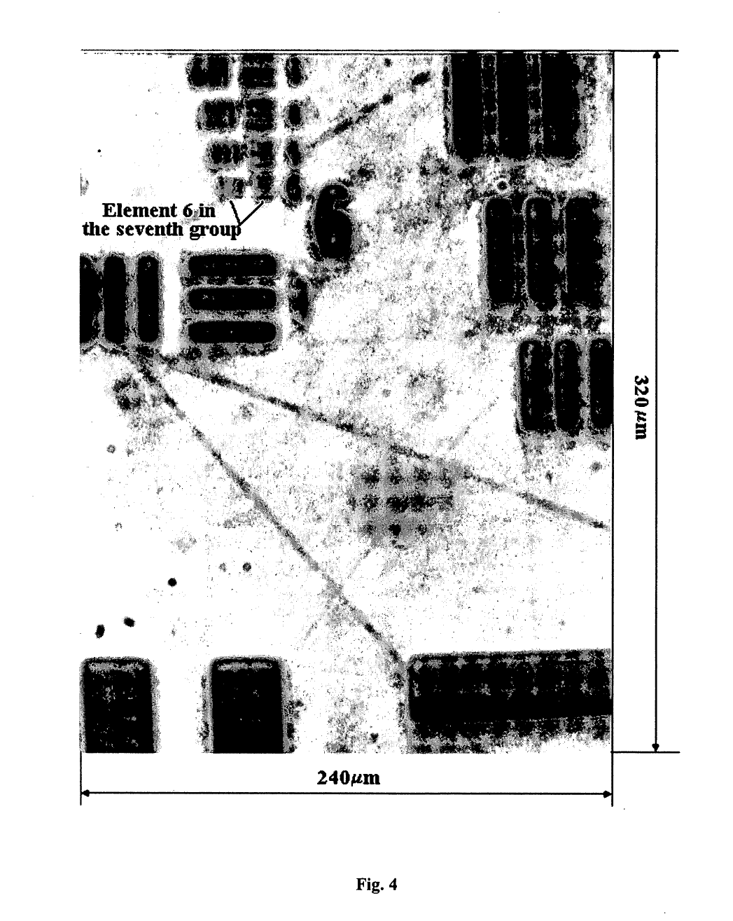

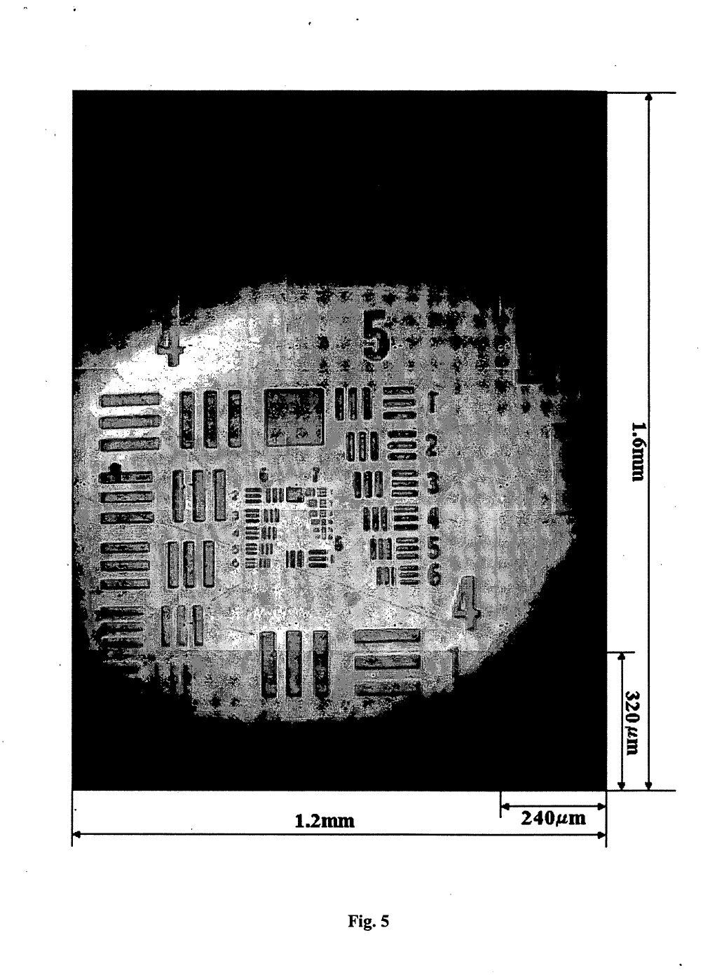

The magnification of this system has the optical magnification 20× and the electronic magnification of 40×, giving a total magnification about 800× for a segmented tile. The repetition rate is set at 10 Hz considering the optical resolution. Each tile has full magnification of 800× for zooming. The composed program was set to scan 25 segment tiles to complete one scanning cycle at the mean time. The CCD was controlled by the composed program to take 25 image tiles to form the full image of the large scanning target. As soon as the one scanning cycle is completed, the program places all image tiles together in order and get one full image of the target. The time to accomplish one cycle is 2.5 seconds. To measure the resolution of the system, a USAF 1951 Target (Edmund) is used as the target object. The USAF target and the Specification Table for this target are shown in FIG. 2. USAF resolution target consists of bars organized in groups and elements (i.e. elements 1-6), and each element is composed of 3 horizontal and 3 vertical equally spaced bars. Each element within a group corresponds to an associated resolution, based on the bar width/space characteristics. After one scanning cycle completed, images of the USAF target consists of 25 segmented images are shown in FIG. 3. Image of the 12^{th} segmented tile of the USAF target is shown in FIG. 4. The bars of the sixth element in Group 7 of USAF target in FIG. 4 is clearly distinguished by the imaging system, which corresponds to the imaging resolution of 4.3×4.3 μm². The 25 stitched segmented tiles form a full image of the USAF target, which is shown in FIG. 5. The dimensions of each segmented tile area are 320×240 μm² and total imaging field of view is 1.6×1.2 mm².

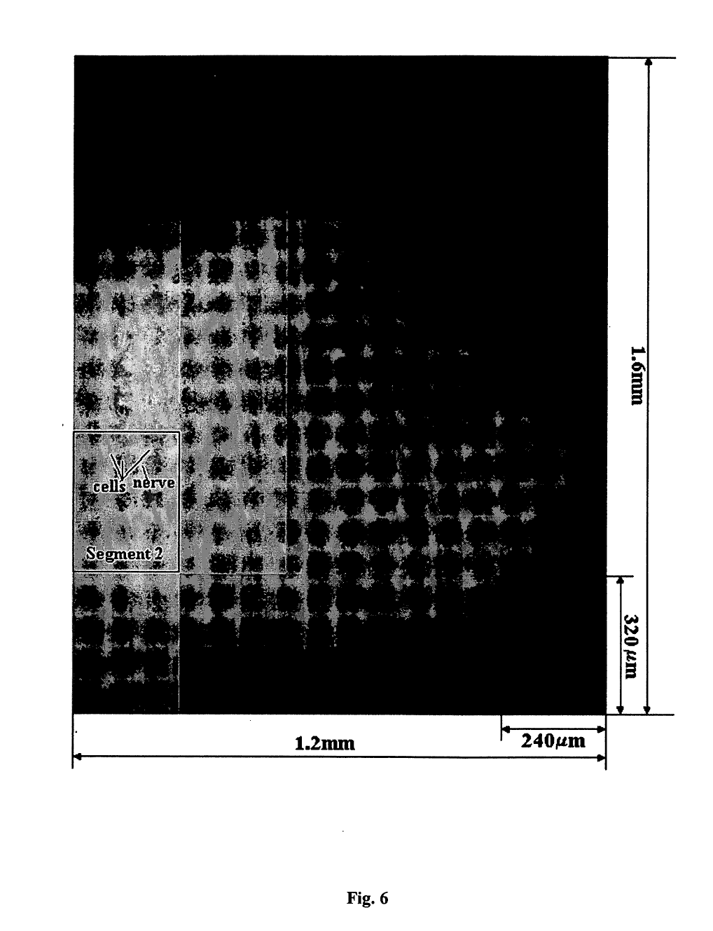

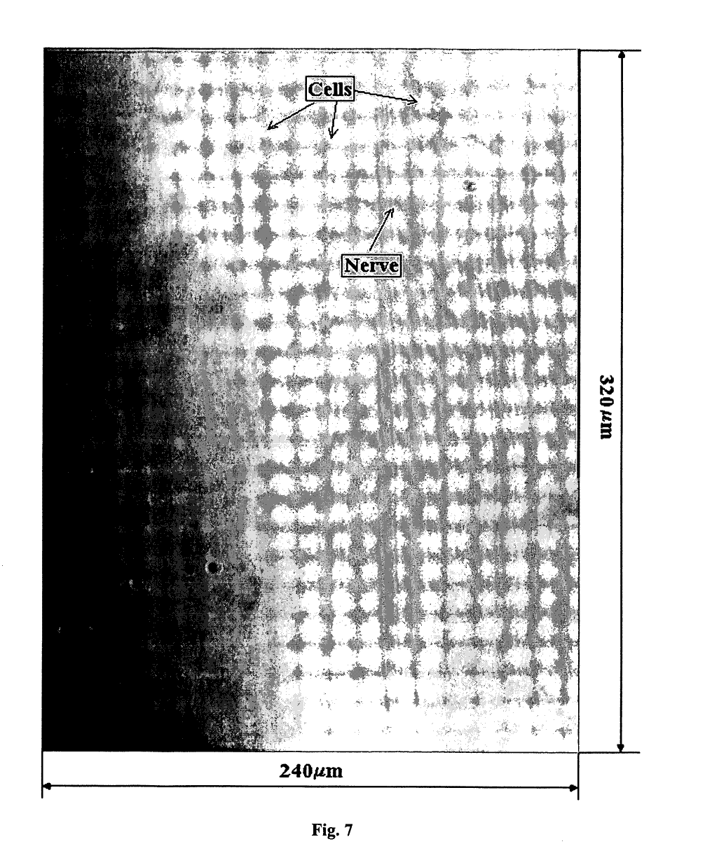

FIG. 6 shows a full segmented tile image of the mouse brain tissue and FIG. 7 is the zoomed tile image of segment #2 of the mouse brain tissue. From this zoomed image, it is easy to distinguish the nerves from the cells.

Femtosecond laser beam can be used as a source to image multiphoton process such as second harmonic, two photon fluorescence, and or higher order nonlinear optical processes over a large field of view in various samples at high resolution.

We claim a method to divide an object in to small segmental tiles with high resolution and recombine the tiles together in order to form the image of the large object using scanners and software.

Although the present invention has been described in some detail by way of illustration and example for purposes of clarity and understanding, it will, of course, be understood that various changes and modifications may be made in the form, details, and arrangements of the parts without departing from the scope of the invention.

We claim:

1. A computer-controlled optical scanning zoom microscope with high magnification and a large field of view, comprising:
a light source;
a microscope with high magnification;
photo detection system;
electronic system for signals processing;
software to combine images; software for image processing;computer based imaging system; and
a scanning system that is one of:
a system composed of an x, y galvanometer mirror system to redirect the image or light collected from a target or sample to a detection system, or
a system composed of a series of mirrors each redirecting the image or light collected from a target or sample to a detection system, and where each image redirected by each mirror corresponds to different areas of the target, or
a system is composed of a single mirror which could redirect at different angles the image or light collected from a target or sample to a detection system, and where each image redirected by each mirror position corresponds to different areas of the target.

2. A microscope according to claim 1 including means for viewing object that can be a tissue, cells, PAP smear, skin cancer, bacteria, semiconductor circuits, biological sample, or medical sample.

3. A microscope according to claim 1 consisting of a light source with at least one wavelength covering in the spectrum range of 260 nm to 1000 nm.

4. A microscope according to claim 1, comprising an optical collecting system for the light source consisting of at least one focusing lens, one collimating lens.

5. A microscope according to claim 1, comprising objective lens L1 (f=8 mm, D=8 mm), imaging Lens L4 (f=30 mm, D=15 mm) and a Galilean-type optical system (5 times ratio) seated between L1 and L4.

6. A microscope according to claim 1, wherein an X,Y scanning system comprises two plane mirrors with axes of rotation perpendicular to each other.

7. A microscope according to claim 1, wherein an X,Y scanning system comprises two one-dimensional galvanometers driven by electrical control board.

8. A microscope according to claim 1, wherein a photodetection system comprises a CCD or a CMOS camera with high scanning repetition rates as high as 30 Hz and sensitive to UV, visible and to the near infrared or Mid infrared spectrum.

9. A computer-based controlling and system consisting of electronic board to manage scanning and data collection and software to produce 2D image tile and stitch all the segmented tile image in order to get a complete segmented image.

10. A method of designing an apparatus for optical scanning zoom microscope with high magnification and a large field of view, comprising the steps of:
selecting an optical system for collecting and collimating LED beam to form a uniform light source;
selecting a beam splitter to couple the uniform beam to illuminate the target;
selecting the microscope parts with magnification greater than 100×;
selecting the scanning system as described in claim 1 to scan the sample to obtain high resolution images;
selecting photodetector sensitive to the wavelength of UV, VIS to NIR;
selecting photodetector sensitive to the wavelength of MID IR;
selecting the electronic system for signal processing;
selecting computer-based imaging system providing 2D image tile of target;
selecting computer-based imaging and processing system for scanning, image acquiring, image saving, imaging compressing and stitching; and
providing the selected uniform light source, optical collecting and collimating system,
X,Y scanning system, photodetection system, electronic system for signal processing, computer-based imaging system, computer-based imaging and processing system in the optical scanning zoom microscope with high magnification and a large field of view, where all the steps above can be performed in any order or simultaneously.

11. The method according to claim 10, wherein the uniform light source is composed of LEDs selected to provide uniform light source of different wavelength of UV, VIS, NIR or Mid IR.

12. The method according to claim 10, wherein the X, Y scanning system is selected to provide X and Y scanning of imaging beam by the angle rotation of the two plane mirrors with orthogonal axis of rotation.

13. The method according to claim 10, wherein the microscope part is selected to provide imaging magnification from 30× to 800×.

14. The method according to claim 10 wherein the photodetection system is selected to provide sensitivity in wavelength range of VIS and NIR

15. The method according to claim 10, wherein computer-based imaging system is selected to provide the imaging tile with magnification of 800×.

16. The method according to claim 10, wherein the computer-based imaging system is selected to provide imaging and acquiring adjacent image tiles of target and then stitching these image tiles in order to get a full composite image.

17. The microscope according to claim 1, wherein software is used to stitch many image tiles to form the composite image of a large target area.

18. The microscope according to claim 1, wherein at least one LED or LEDS array has a wavelength range from UV to Near Infrared or Mid infrared.

19. The microscope according to claim 1, in which photo detection imaging devices are used with a wavelength range from UV to NIR.

20. The microscope according to claim 1, wherein optical and electrical magnification is provided to 1000×.

21. The method according to claim 10, used to monitor large areas and concentrate and focus in smaller areas where changes and differences exist or are taking place.

22. The method according to claim 10, used to focus on cells array by focusing on region to be magnified for analysis of diseases such as PAP smear to determine and focus on abnormal and cancer cell regions.

23. The method according to claim 10, used to segment the image for an application selected from the group of fluorescence microscope, multiphoton microscope (two photon, three photon), or harmonic microscope (second harmonic, three harmonic) in biological, semiconductor and medical samples using fs laser excitation source.
